(19) United States
(12) Patent Application Publication
(10) Pub. No.: US 2025/0018373 A1
(43) Pub. Date: Jan. 16, 2025

(54) STRUCTURAL GAS TREATMENT BODIES FOR CARBON CAPTURE

(71) Applicant: Cormetech, Inc., Durham, NC (US)

(72) Inventors: Chris Bertole, Durham, NC (US); Chris E. DiFrancesco, Durham, NC (US)

(21) Appl. No.: 18/714,331

(22) PCT Filed: Nov. 29, 2022
(86) PCT No.: PCT/US2022/051242

§ 371 Date: May 29, 2024

Related U.S. Application Data
(60) Provisional application No. 63/283,784, filed on Nov. 29, 2021.

(51) Int. Cl. B01J 20/32; B01D 53/02; B01J 20/02; B01J 20/08; B01J 20/26; B01J 20/28

(52) U.S. Cl. CPC B01J 20/327; B01D 53/02; B01J 20/0211; B01J 20/08; B01J 20/261; B01J 20/28011; B01J 20/28045; B01J 20/28059; B01J 20/28061; B01J 20/3204; B01D 2253/202; B01D 2257/504; B01D 2258/06

(57) ABSTRACT

In one aspect, monolithic structural gas treatment bodies are described herein comprising a unique hierarchical pore structure and thin-walled honeycomb architecture in conjunction with high open area and sufficient size and mechanical strength for commercial and industrial applications, including carbon capture applications. As described further herein, the monolithic structural gas treatment body can exhibit a honeycomb structure wherein inner partition walls define longitudinal flow channels through the monolithic body.

### RELATED APPLICATION DATA

The present application claims priority pursuant to Article 8 of the Patent Cooperation Treaty to U.S. Provisional Patent Application Ser. No. 63/283,784 filed Nov. 29, 2021, which is incorporated herein by reference in its entirety.

### FIELD

The present invention related to monolithic structural bodies for gas treatment applications and, in particular, to such bodies for the removal of carbon dioxide (CO₂) from gas streams via adsorption.

### BACKGROUND

Global warming and associated climate change induced by human activities presents an existential threat to numerous ecosystems and the way of human life as it is currently understood. The mining and burning of fossil fuels are chief contributors global warming via the massive release of heat trapping gases, including methane and carbon dioxide. Carbon dioxide accounts for the bulk of greenhouse gas emissions, as the concentration of carbon dioxide has eclipsed the 400 ppm mark in recent years. Current carbon dioxide levels exceed any concentration in the last 800,000 years.

In view of this alarming trend in atmospheric carbon dioxide concentration, countries and industry have initiated various mitigation strategies to reduce carbon dioxide emissions, as well as methane emissions. Electrification of vehicles and transportation systems has drawn considerable attention. Moreover, the transition to green/renewable sources of energy, including wind and solar, has received significant private and public investment. While promising, these mitigation strategies fail to address carbon dioxide that is currently in the atmosphere. Accordingly, current carbon dioxide levels are left to slow, natural degradation processes.

### SUMMARY

In one aspect, monolithic structural bodies are described herein for the capture of carbon dioxide from the ambient atmosphere and/or sources of exhaust gases. A monolithic structural gas treatment body, in some embodiments, comprises an outer peripheral wall, and a plurality of inner partition walls having dispersed throughout a carrier comprising an inorganic oxide composition, the carrier comprising an hierarchical pore structure having a macroporosity of at least 0.24-1.0 cc/g in pores of diameter ranging from 600 to 50,000 Angstroms, and a mesoporosity of at least 0.17 cc/g in pores of diameter ranging from 20 to 300 Angstroms, wherein a total porosity of the carrier is at least 0.41 cc/g in pores of diameter ranging from 20-100,000 Angstroms. In addition to the carrier having the foregoing inorganic oxide composition and hierarchical pore structure, the monolithic structural gas treatment body has the following structural features:
(a) hydraulic diameter of at least 100 mm;
(b) at least 85 cells per square inch (cpsi);
(c) average thickness of the inner partition walls of 0.1 mm to 0.3 mm;
(d) open frontal area of at least 65 percent; and
(e) transverse compressive strength of at least 500 g/cm².

Moreover, in some embodiments, the monolithic structural gas treatment body further comprises one or more chemical species operable for the capture of carbon dioxide (CO₂) from a gas stream flowed monolithic structural gas treatment body. The one or more chemical species, for example, can operate to adsorb CO₂ from the gas stream. The one or more chemical species operable for the adsorption of CO₂ from the gas stream are associated with the carrier exhibiting the hierarchical pore structure. The one or more chemical species for CO₂ adsorption can be dispersed throughout the carrier, residing in the mesopores, macropores or combinations thereof of the hierarchical pore structure. In being associated with the carrier, the chemical species for CO₂ adsorption can be dispersed throughout the inner partition walls. Such structure is fundamentally different than a washcoat where a refractory oxide layer is coated onto a substrate as a support for adsorber chemical species. Additionally, the gas stream can be ambient air or an exhaust gas stream. The chemical species, as described further herein, can be organic compounds or inorganic compounds.

In another aspect, methods of treating gas streams are described herein. A method, in some embodiments, comprises providing a monolithic structural gas treatment body, flowing a gas stream through the monolithic structural gas treatment body, and adsorbing CO₂ from the gas stream with the monolithic structural gas treatment body. In addition to properties (a)-(e) above, the monolithic structural gas treatment body comprises an outer peripheral wall, and a plurality of inner partition walls having dispersed throughout a carrier comprising an inorganic oxide composition, the carrier comprising an hierarchical pore structure having a macroporosity of at least 0.24-1.0 cc/g in pores of diameter ranging from 600 to 50,000 Angstroms, and a mesoporosity of at least 0.17 cc/g in pores of diameter ranging from 20 to 300 Angstroms, wherein a total porosity of the carrier is at least 0.41 cc/g in pores of diameter ranging from 20-100,000 Angstroms. One or more chemical species operable for the adsorption of CO₂ from the gas stream are associated with the carrier exhibiting the hierarchical pore structure.

In some embodiments, a method of treating a gas stream further comprises desorbing the CO₂ captured by the monolithic structural gas treatment body. The captured CO₂ can be desorbed by heating the monolithic structural gas treatment body. In some embodiments, the monolithic structural gas treatment body is heated with steam or heated nitrogen (N₂) to desorb the captured CO₂. Once desorbed, the CO₂ is further processed and stored.

These and other embodiments are further described in the following detailed description.

### BRIEF DESCRIPTION OF THE DRAWINGS

FIG. 1 illustrates a honeycomb-like monolithic structural gas treatment body according to some embodiments herein.

FIG. 2 illustrates flow channels defined by the inner partition walls in a honeycomb-like monolithic structural catalyst body according to some embodiments herein.

FIG. 3 illustrates a method of determining the average thickness of the outer peripheral wall and inner partition walls of a monolithic structural gas treatment body.

FIG. 4 illustrates a plan view of a module containing monolithic structural gas treatment bodies according to some embodiments.

FIG. 5 illustrates CO₂ capture performance of a monolithic structural gas treatment body according to some embodiments herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Monolithic Structural Gas Treatment Bodies

In one aspect, monolithic structural gas treatment bodies are described herein comprising a unique hierarchical pore structure and thin-walled honeycomb architecture in conjunction with high open area and sufficient size and mechanical strength for commercial and industrial applications, including carbon capture applications. As described further herein, the monolithic structural gas treatment body can exhibit a honeycomb structure wherein inner partition walls define longitudinal flow channels through the monolithic body.

A monolithic structural gas treatment body, in some embodiments, comprises an outer peripheral wall, and a plurality of inner partition walls having dispersed throughout a carrier comprising an inorganic oxide composition, the carrier comprising an hierarchical pore structure having a macroporosity of at least 0.24-1.0 cc/g in pores of diameter ranging from 600 to 50,000 Angstroms, and a mesoporosity of at least 0.17 cc/g in pores of diameter ranging from 20 to 300 Angstroms, wherein a total porosity of the carrier is at least 0.41 cc/g in pores of diameter ranging from 20-100,000 Angstroms. In addition to the carrier having the foregoing inorganic oxide composition and hierarchical pore structure, the monolithic structural gas treatment body has the following structural features:
(a) hydraulic diameter of at least 100 mm;
(b) at least 85 cells per square inch (cpsi);
(c) average thickness of the inner partition walls of 0.1 mm to 0.3 mm;
(d) open frontal area of at least 65 percent; and
(e) transverse compressive strength of at least 500 g/cm².

Turning now to specific components, the outer peripheral wall, and a plurality of inner partition walls having dispersed throughout a carrier comprising an inorganic oxide composition. In being dispersed throughout the outer peripheral wall and inner partition walls, the carrier comprising the inorganic oxide composition, in some embodiments, forms the outer partition wall and inner partition walls. The carrier can include any inorganic oxide not inconsistent with the technical objectives described herein. In some embodiments, the inorganic oxide comprises at least one of titania (TiO₂), alumina (Al₂O₃), and zirconia (ZrO₂). In some embodiments, the inorganic oxide composition is titania based or alumina based. Alumina of the inorganic oxide can comprise one or more polymorphs, including gamma alumina. In being titania or alumina based, titania or alumina is the inorganic oxide present in the highest amount of the composition. In some embodiments, for example, an alumina based inorganic oxide composition comprises alumina in an amount of 40-100 wt. %. Similarly, a titania based inorganic oxide composition, in some embodiments, comprises titania in an amount of 40-100 wt. %.

The carrier, in some embodiments, comprises the inorganic oxide composition in an amount of 50-100 wt. %. In some embodiments, the inorganic oxide of the carrier does not substantially include oxides of tungsten, vanadium, and/or molybdenum. For example, the inorganic oxide of the carrier comprises less than 5 wt. %, less than 3 wt. %, less than 1 wt. % of oxides of tungsten, vanadium, and/or molybdenum. Moreover, the inorganic oxide composition, in some embodiments, includes less than 100 ppm iron or iron compounds, the iron or iron compounds operable for the oxidation and/or other degradation of CO₂ capture functionalities, such as amine functionalities, associated with the carrier. The carrier may further comprise fillers and/or reinforcement agent, as described further herein.

The carrier exhibits a hierarchical pore structure having a macroporosity of 0.24-1.0 cc/g cc/g in pores of diameter ranging from 600 to 50,000 Angstroms. In some embodiments, the macroporosity ranges from 0.30 cc/g to 0.70 cc/g in pores of diameter ranging from 600 to 50,000 Angstroms. Macroporosity of the carrier can also have a value selected from Table I.

TABLE I
Macroporosity of Carrier in pores of diameter
ranging from 600 to 50,000 Angstroms
0.24-0.60
0.24-0.55
0.24-0.50
0.24-0.45
0.24-0.40
0.30-0.55
0.30-0.40
0.35-0.55

In some embodiments, macroporosity of the carrier comprises a first porosity distribution of at least 0.08 cc/g in pores of diameter ranging from 600 to 5,000 Angstroms, and a second porosity distribution of at least 0.16 g/cc in pores of diameter ranging from greater than 5,000 Angstroms up to 50,000 Angstroms, wherein the summation of the first and second porosity distributions fall within the total macroporosity range of 0.24 to 1.0 cc/g. In some embodiments, the macroporosity is bimodal or multimodal, wherein the sum of the individual modes yields the total macroporosity. The first porosity distribution, in some embodiments, is greater than the second porosity distribution of the macroporosity. Alternatively, the second porosity distribution of the macroporosity can be greater than the first porosity distribution. Additionally, in some embodiments, D₅₀ of the pore diameter of the macroporosity is less than 700 nm or less than 600 nm. In some embodiments, pore diameter D₅₀ of the macroporosity is 400 nm to 700 μm or 450 nm to 700 nm.

In addition to macroporosity, the carrier has a mesoporosity of at least 0.17 cc/g in pores of diameter ranging from 20 to 300 Angstroms. In some embodiments, the carrier has mesoporosity of at least 0.30 cc/g in pores of 20 to 300 Angstroms. Mesoporosity of the carrier can also have a value selected from Table II.

TABLE II
Mesoporosity of Carrier in pores of diameter
ranging from 20 to 300 Angstroms
0.17-0.70
0.20-0.60
0.20-0.55
0.20-0.50
0.25-0.45
0.30-0.55
0.35-0.60
0.17-0.30
0.17-0.25

Mesoporosity of the carrier, in some embodiments exhibits a D₉₀ pore diameter of 50 nm to 70 nm. Moreover, in some embodiments, the mesoporosity has a D₅₀ pore diameter having a value of 10-20 nm, 11-20 nm, 12-20 nm, 15-20 nm, or 15-40 nm. Additionally, a ratio of mesoporosity to macroporosity of the carrier can be greater than 1, such as greater than 1.1 or greater than 1.2. In other embodiments, the ratio of mesoporosity to macroporosity of the carrier is less than 1, such as 0.5 to 0.8.

Total porosity of the carrier is at least 0.41 cc/g in pores of diameter ranging from 20-100,000 Angstroms. In some embodiments, total porosity of the carrier is 0.41 to 1.5 cc/g in pores of diameter ranging from 20-100,000 Angstroms. Total porosity of the carrier can also have a value selected form Table III.

TABLE III
Total Pore Volume of Carrier in pores of diameter
ranging from 20 to 100,00 Angstroms
0.50-1.3
0.5-1.25
0.5-1.15
0.5-1.10
0.5-1.05
0.5-1
0.45-0.90
0.45-0.85
0.45-0.80

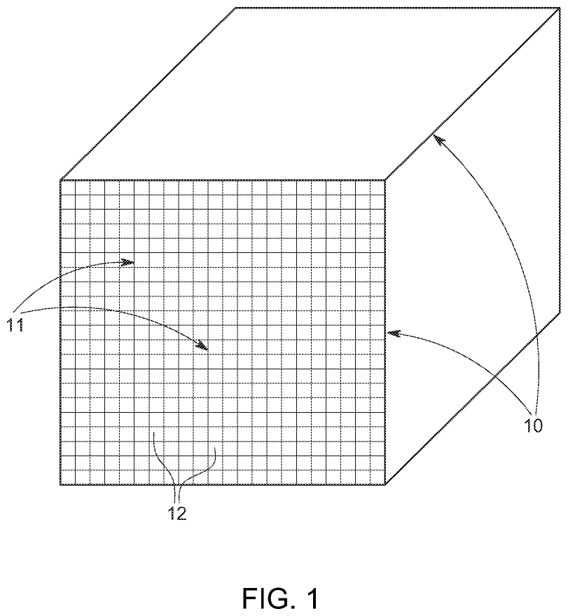

As described herein, the carrier having the foregoing hierarchical pore structure is dispersed throughout the outer peripheral wall and inner partition walls of the monolithic structural gas treatment body. In some embodiments, the carrier comprising the inorganic oxide composition forms the outer peripheral wall and inner partition walls of the structural gas treatment body. The inner partition walls are arranged inside the dimensions defined by the outer peripheral wall, and plurality of flow channels are defined by the inner partition walls, the flow channels extending longitudinally through the monolithic structural gas treatment body. FIG. 1 illustrates a honeycomb-like monolithic structural gas treatment body according to some embodiments herein. The honeycomb-like structural gas treatment body in the embodiment of FIG. 1 comprises an outer peripheral wall 10 and a plurality of inner partition walls 11. The inner partition walls 11 define a plurality of flow channels 12 extending longitudinally through the honeycomb-like monolithic structural gas treatment body.

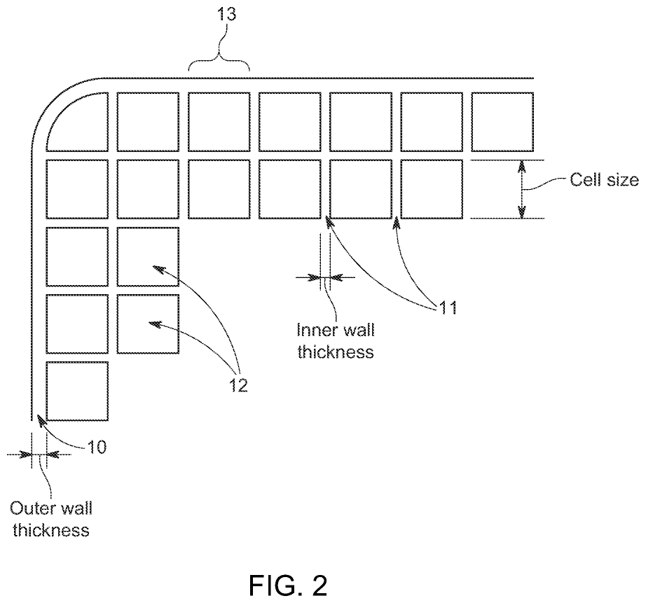

FIG. 2 illustrates flow channels 12 defined by the inner partition walls 11 in a honeycomb-like monolithic structural catalyst body according to some embodiments herein. The inner partition walls 11 and their junctures with the outer peripheral wall serve as boundaries for adjacent flow channels 12. When a portion of the outer peripheral wall 10 serves as a boundary for a flow channel 12, that portion may be referred to as an outer peripheral wall segment 13. As illustrated in FIGS. 1 and 2, the flow channels 12 establish a flow channel density or cell density over the inlet and outlet faces of the monolithic structural gas treatment body. A monolithic structural gas treatment body described herein can have any desired cell density or flow channel density. As described above, the monolithic structural gas treatment body has a cell density of at least 85 cpsi. In some embodiments, the monolithic structural gas treatment body has a cell density of 100 cpsi to 900 cpsi. For example, the monolithic structural gas treatment body can have a cell density of 100 cpsi to 500 cpsi, 140 cpsi to 450 cpsi, or 170 cpsi to 500 cpsi. Additionally, length of the flow channels or cells, in some embodiments, is at least 100 mm or at least 110 mm. In some embodiments, length of the flow channels of cells of the monolithic structural has treatment body is at least 120 mm or at least 125 mm.

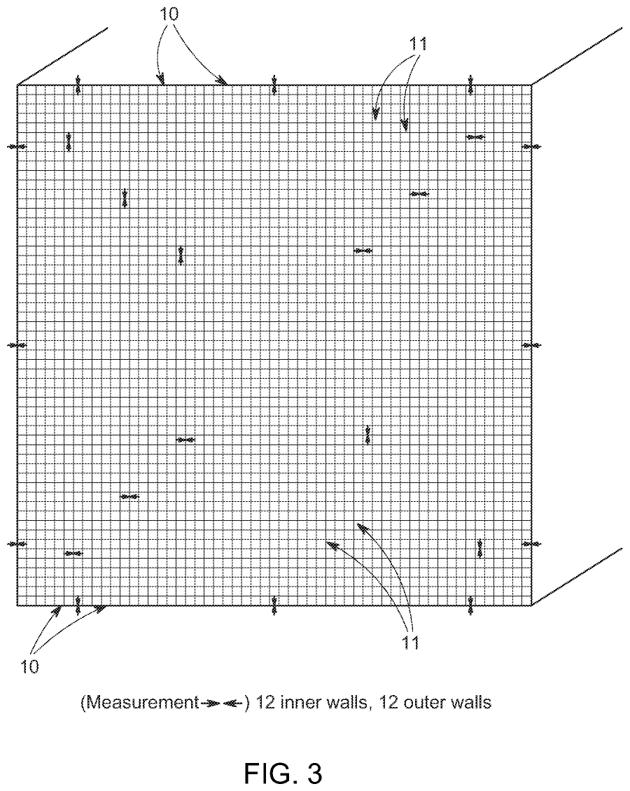

Moreover, as provided above, the inner partition wall thickness of a monolithic structural gas treatment body is 0.1 mm to 0.3 mm. In some embodiments, the inner partition wall thickness can be 0.1 mm to 0.25 mm, 0.1 mm to 0.2 mm, 0.1 mm to 0.25 mm, 0.15 mm to 0.25 mm, or 0.15 mm to 0.2 mm. The thickness of the outer peripheral wall and inner partition walls are determined with a caliper or micrometer with a resolution of 0.01 mm. FIG. 3 illustrates a method of determining the average thickness of the outer peripheral wall 10 and inner partition walls 11. The thickness of the outer peripheral wall 10 is measured in twelve (12) different locations on the catalyst body sample. The twelve measuring locations comprise three points on each side of the square outer peripheral wall as demonstrated in FIG. 3. The average thickness of the outer peripheral wall 10 is calculated by averaging the values obtained from the twelve (12) measurements. Similarly, the average thickness of the inner partition walls 11 is determined by initially measuring the thickness of the inner partition walls 11 at twelve (12) different locations throughout the catalyst body. The inner partition walls 11 are measured in the horizontal and vertical directions as displayed in FIG. 3. The average thickness of the inner partition walls 11 is calculated by averaging the values obtained in the twelve measurements.

Thin inner partition walls can assist in achieving high cpsi without sacrificing open frontal area of the monolithic structural gas treatment body and/or inducing undesirable pressure drop sustained by gas flow through the monolithic structural body. The open frontal area (OFA) of the monolithic structural gas treatment body is that portion of the body cross-section available for gas flow on a cross-sectional surface normal to the direction of gas flow. An increased open frontal area can result in more efficient fluid flow characteristics within the monolithic body, which can decrease the pressure drop sustained by fluids passing through the monolithic structural gas treatment body. A monolithic structural gas treatment body described herein has an OFA of at least 65 percent. In some embodiments, a monolithic structural gas treatment body has an OFA of at least 70 percent or at least 80 percent. OFA of a monolithic structural gas treatment body can range from 65-90 percent, 65-85 percent, 70-90 percent, 70-80 percent, 75-85 percent, or 80-90 percent, in some embodiments.

As described above, a monolithic structural gas treatment body also has a hydraulic diameter of at least 100 mm. The hydraulic diameter of the catalyst body is defined as being equal to the cross-sectional area perpendicular to the direction of flow of the catalyst body multiplied by four and divided by the value of the outer perimeter of the outer peripheral wall. When the monolithic structural catalyst body displays a circular cross-sectional geometry, the hydraulic diameter is equal to the diameter of the circular cross-sectional area. In the case of a square cross-sectional geometry, the hydraulic diameter is equal to the length or width of a side. Accordingly, the hydraulic diameter characterizes the size of the monolithic structural gas treatment body with larger values of hydraulic diameter corresponding to larger monolithic structural gas treatment bodies. In some embodiments, the monolithic structural gas treatment body has a hydraulic diameter of at least 120 mm or at least 130 mm. The hydraulic diameter of the monolithic structural gas treatment body can range from 100 mm to 150 mm, from 120 mm to 150 mm, or from 130 mm to 150 mm. In some embodiments, hydraulic diameter of the monolithic structural gas treatment body can be greater than 150 mm. Hydraulic diameter of the monolithic structure gas treatment body can have an upper limit of 300 mm, in some embodiments.

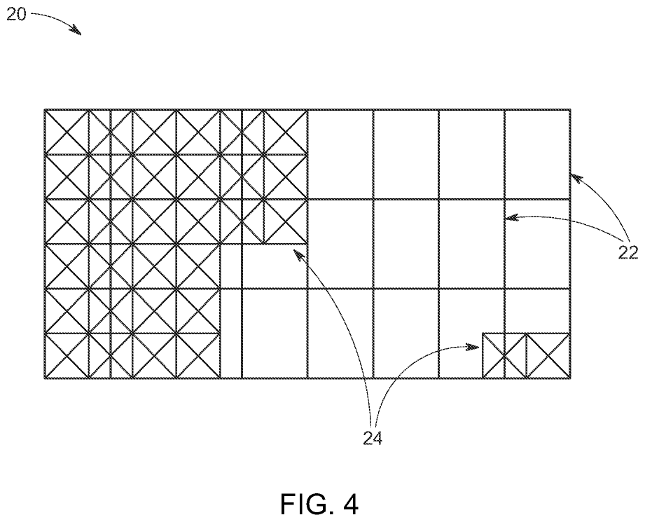

In addition to the thin inner partition walls, high OFA, large hydraulic diameter, and high porosity provided by the hierarchical pore structure, the monolithic structural gas treatment body also exhibits transverse compressive strength sufficient to permit use of the monolithic body in industrial gas treatment applications. Insufficient transverse compressive strength can preclude arrangement or packing of the monolithic structural gas treatment bodies in modules and/or other configurations for industrial gas treatment applications. When arranged in modules, the monolithic structural gas treatment bodies experience compressive forces resulting from pressure between the gas treatment bodies as they are assembled side-by-side with or without sealing material, and also when stacked on top of each other, with or without sealing material, to form an array large enough to treat a meaningful amount of gas. FIG. 4 illustrates a plan view of a module containing monolithic structural gas treatment bodies according to some embodiments. The module 20 comprises an open metal framework 22 for supporting monolithic structural bodies 24 disposed therein. The monolithic structural gas treatment bodies 24 are arranged side-by-side. In some embodiments, packing material, cement, or silicone resides between one or more sides of adjacent monolithic bodies to prevent gas flow around the monolithic bodies.

In some embodiments, the monolithic structural gas treatment body exhibits a transverse compressive strength of at least 500 g/cm². Transverse compressive strength of the monolithic structural gas treatment body can also have a value selected from Table IV.

TABLE IV
Transverse Compressive Strength (g/cm²)

≥600
≥750
≥800
≥1,000
500-1,000
750-1,300

The transverse compressive strengths of the monolithic structural catalyst bodies of the present invention may be measured with a compressive testing apparatus such as Tinius Olson 60,000 lb. Super “L” Compression Testing Machine that displays a maximum compression load of 30,000 kg and can be obtained from Tinius Olsen of Willow Grove, Pa. Samples for transverse compressive strength testing may be prepared by cutting a monolithic structural catalyst into sections typically of 150 mm in length, but at least 50 mm in length, wherein each section can serve as an individual test sample.

Ceramic wool of 6 mm thickness may be spread under and over the pressure surface of the sample, and the wrapped sample set in a vinyl bag in the center of the pressure plates. The pressure plates used in the testing may be stainless steel with dimensions of 160 mm×160 mm. Transverse compression strength is quantified with the side surface on the bottom with the compressive load applied in the direction parallel to the cross-section of the honeycomb structure and perpendicular to the partition walls. The compressive load is thus applied in the direction normal to the direction of flow in the flow channels. The compressive load can be applied as delineated in Table V.

TABLE V
Compressive Loads
Compressive Speed
25 kg/s
50 kg/s

The maximum transverse compressive load W (g) withstood by the samples is registered by the apparatus. The transverse compressive strength is subsequently calculated from the maximum compressive load in grams-force (gr) by dividing the value of the maximum compressive load by the surface area over which the load was applied.

In embodiments where the monolithic structural body does not lie flat, such as when the body has an overall circular or oval cross-sectional geometry, a subsection of the body is cut from the overall sample for testing. The subsection is cut so as to produce a sample with upper and lower flat surfaces. The remainder of the strength testing proceeds in a manner consistent with that previously described.

Notably, the high porosity provided by the hierarchical pore structure, the thin inner partition walls, and high OFA individually and collectively contribute to reducing or weakening transverse compressive strength of the monolithic structural gas treatment body. These structural characteristics also restrict the hydraulic diameter of the monolithic structural gas treatment body as increases in body strength are required to support increases in body size. For these reasons, prior monolithic structural gas treatment bodies have not achieved the combination of thin inner partition walls, high OFA, and hierarchical pore structure described herein in conjunction with hydraulic diameters of at least 100 mm and transverse compressive strengths of at least 500 m²/g. Prior monolithic structural gas treatment bodies exhibiting various hierarchical pore structures and thin inner partition walls, for example, have been limited to significantly smaller sizes having maximum hydraulic diameter of 25 mm or less. Such monolithic bodies are too small to find useful application in industrial or large scale gas treatment applications.

The monolithic structural gas treatment bodies described herein overcome these disadvantages by provided sufficient size/hydraulic diameter and transverse compressive strength without sacrificing thin inner partition wall thickness, high OFA, and hierarchical pore structure exhibit desirable mesopore and macropore volumes. As described further herein, care must be taken to minimize the amount of shear energy and pressure exerted on the carrier inorganic oxide during mixing and extrusion in order to preserve macro and meso porosity. However, in order to make a large hydraulic diameter product with high OFA and thin inner partition walls, the inorganic oxide material for extrusion must be stiff enough such that the structural monolithic body can support its own weight during processing and prevent deformation of walls that may result in lower strength of the final monolithic structural body. The stiffer the inorganic oxide material, the more shear and pressure must be applied to mix and force through the honeycomb die. Also, the higher the OFA and thinner the wall, the more pressure required to force the inorganic oxide material through the die. The die itself must then be thicker in the direction of material flow to withstand this pressure to prevent the die from yielding. Also, as the hydraulic diameter increase the die must also become substantially thicker to prevent the die from yielding. Ultimately a die thickness is reached that can accommodate the stiff batch and prevent the die from yielding. In contrast, to make a much smaller hydraulic diameter product and/or thicker walled product, and/or lower OFA product, the die can be much thinner and the inorganic oxide material much less stiff, making it much easier to maintain high macro and meso porosities. However, a small hydraulic diameter product is not practical for use, since many more would need to be assembled together to treat the gas. Also a low OFA product would cause large parasitic energy losses during processing of the gas due to higher back-pressure. A thicker walled product is not advantageous, since in many cases thermal mass is just being added which is not used in the gas treatment process, which may just use the near surface of the wall.

When producing monolithic structural gas treatment bodies described herein, lubricants and other extrusion aids are used to reduce shear stress and pressures in processing. Mixing energy, through motor amperage, can be monitored and mixing cycle optimized to minimize mixing energy. Extruder tolerances may be maintained, flow transitions minimized, and/or more positive pressure extruders may be used to minimize shear stresses during extrusion. Dies may be designed to minimize internal pressure losses during extrusion, such as a tapered entrance into the open channels at the entrance of the die. Die surfaces may also be designed to minimize friction in the die, such as polishing inner surfaces and using nickel plating. Conveying systems downstream of the extruder may be designed to minimize forces placed on the extrudate to minimize how stiff the batch must be, such as using foam conveyor surfaces or air bearings.

Monolithic structural gas treatment bodies described herein, in some embodiments, can further comprise inorganic binder and/or reinforcement agents. In some embodiments, inorganic binder and/or one or more reinforcement agents can be present in the monolithic gas treatment body in an amount of 3-30 weight percent. Reinforcement agents can include reinforcing fibers, including glass (SiO₂) fibers, carbide fibers, ceramic fibers, and mixtures thereof. In some embodiments, reinforcing fibers have a diameter of 3 μm to 10 μm. Inorganic binder and/or reinforcement agents can be added to the inorganic oxide extrusion batch. Extrusion conditions described herein are carefully controlled when employing fiber reinforcements as such reinforcements can complicate or interfere with producing the desired mesoporosity and macroporosity of the hierarchical pore structure. The extrusion system may include extruder machines, a filter or screen, and an extrusion die. The filter or screen may be utilized to facilitate passage of the mixture through the die while minimizing shear stresses. Particles that can clog the die are removed without removing filler, binders, glass fibers and/or other reinforcement agents that provide advantageous product properties. In some embodiments, for example, a wedge-shaped screen is employed to prevent or mitigate removal of fiber reinforcements from the mixture.

Monolithic structural gas treatment bodies described herein, in some embodiments, can further comprise one or more chemical species operable for the capture of CO₂ from a gas stream flowed monolithic structural gas treatment body. Accordingly, a monolithic structural gas treatment body not comprising one or more chemical species operable for the capture of CO₂ can be considered a substrate for the one or more chemical species operable for the capture of CO₂. The one or more chemical species, for example, can operate to adsorb CO₂ from the gas stream. The one or more chemical species operable for the adsorption of CO₂ from the gas stream are associated with the carrier exhibiting the hierarchical pore structure. The one or more chemical species for CO₂ adsorption can be dispersed throughout the carrier, residing in the mesopores, macropores or combinations thereof of the hierarchical pore structure. In being associated with the carrier, the chemical species for CO₂ adsorption can be dispersed throughout the inner partition walls. Such structure is fundamentally different than a washcoat where a refractory oxide layer is coated onto a substrate as a support for adsorber chemical species. Additionally, the gas stream can be ambient air or an exhaust gas stream.

The chemical species for CO₂ adsorption can be organic compounds or inorganic compounds. In some embodiments, the chemical species comprises one or more organic compounds containing amine functionalities for CO₂ adsorption. For example, the chemical species can comprise one or more polymeric species comprising amine functionalities. In some embodiments, polymeric species comprise polyalkyleneimines, including polyethyleneimine, polypropyleneimine or combinations thereof. Polymeric species comprising amine functionalities for CO₂ adsorption can be linear, branched, or hyper-branched (dendrimer). Polymeric species comprising amine functionalities for CO₂ adsorption can included homopolymers, copolymers, and graft copolymers. Organic compounds comprising amine functionalities for CO₂ adsorption can also include small (non-polymeric) molecules, such as tetra(ethylenepentamine) (TEPA).

As described herein, the organic compounds comprising amine functionalities for CO₂ adsorption can be dispersed throughout the carrier, residing in the mesopores, macropores or combinations thereof of the hierarchical pore structure. In some embodiments, a ratio of organic compound comprising CO₂ capture functionalities residing in the mesopores relative to organic compound comprising CO₂ capture functionalities residing in the macropores is greater than 1. In some embodiments, the ratio ranges from 1.5 to 10 or 2 to 5. Additionally, in some embodiments, at least 80 percent of the organic compound comprising CO₂ capture functionalities resides in the mesopores. In some embodiments, 80 to 90 percent of the organic compound comprising CO₂ capture functionalities resides in the mesopores. Additionally, in some embodiments, at least 75 percent of the organic compound comprising CO₂ capture functionalities resides in the mesopores, wherein total mesopore volume is reduced less than 70 percent by the inclusion of the organic compound.

Organic compounds comprising amine functionalities for CO₂ adsorption can form one or more interactions with the inorganic oxide composition of the carrier. In some embodiments, the organic compounds form van der Waals interactions and/or ionic interactions with the carrier inorganic oxide composition forming the mesopores and/or macropores. In other embodiments, the organic compounds can covalently bind to the inorganic oxide composition. The organic compounds, for example, can comprise one or more functionalities for reacting with surface functionalities of the inorganic oxide, such as hydroxide, oxide, and/or carboxyl surface functionalities. In some embodiments, a chemical linker can be employed to covalently bind the organic compounds comprising amine functionalities to the carrier inorganic oxide composition. Organic compounds comprising amine functionalities for CO₂ adsorption can partially fill mesopores and/or macropores of the carrier hierarchical pore structure. Additionally, the organic compounds, in some embodiments, can be uniformly or substantially uniformly distributed within the mesopores and/or macropores along the entire length of the flow channels or cells of the monolithic structural gas treatment body. Organic compounds comprising amine functionalities for CO₂ adsorption, in some embodiments, can be present in the monolithic structural gas treatment body in an amount of at least 10 weight percent. In some embodiments, the organic compounds are present in the monolithic structural gas treatment body in an amount of 10 weight percent to 30 weight percent.

In some embodiments, inclusion of organic compounds comprising amine functionalities for CO₂ adsorption in the carrier hierarchical pore structure increases the transverse compressive strength of the monolithic structural gas treatment body relative to the naked monolithic body. For example, in some embodiments, including one or more organic compounds in at least 40 percent of the mesoporosity increases transverse compressive strength of the monolithic body by at least 50 percent relative to the naked or bare monolithic body.

To facilitate enhanced performance lifetimes of the monolithic structural gas treatment bodies described herein, the inorganic oxide composition of the carrier can be free or substantially free of compounds including metals operable to oxidize the organic compounds comprising amine functionalities for CO₂ adsorption. In some embodiments, the inorganic oxide composition is free or substantially free of compounds, including oxides, comprising metals selected from the group consisting of tungsten, vanadium, iron, chromium, and/or molybdenum. For example, the inorganic oxide of the carrier comprises less than 5 wt. %, less than 3 wt. %, less than 1 wt. % of compounds of tungsten, vanadium, and/or molybdenum. Moreover, the inorganic oxide composition, in some embodiments, includes less than 100 ppm iron or iron compounds, the iron or iron compounds operable for the oxidation and/or other degradation of CO₂ capture functionalities, such as amine functionalities, associated with the carrier.

A monolithic structural has treatment body described herein comprising one or more organic compounds comprising amine functionalities in the carrier hierarchical pore structure, in some embodiments, can adsorb at least 15 g or at least 25 g of CO₂ per kilogram of the monolithic structural gas treatment body within 15 minutes at the following conditions:
1. Gas stream—ambient air or simulated air at 35° C. with 450 ppm CO₂, 20% O₂, and 2% H₂O by volume; and
2. Space velocity of gas stream—110,000 hr⁻¹.

After 100 minutes at the same conditions, the monolithic structural gas treatment body can adsorb at least 35 or at least 45 g of CO₂ per kilogram of the monolithic structural gas treatment body.

A monolithic structural has treatment body described herein comprising one or more organic compounds comprising amine functionalities in the carrier hierarchical pore structure, in some embodiments, can adsorb at least 10 g of CO₂ per kilogram of the monolithic structural gas treatment body within 2 minutes at the following conditions:
1. Gas stream—exhaust gas or simulated exhaust gas resulting from combustion of fossil fuel in air, 80° C. and 4% CO₂ by volume; and
2. Space velocity of gas stream 3,000 hr⁻¹.

The foregoing CO₂ adsorption profiles are dependent on specific construction of the monolithic structural gas treatment body including specific chemical identity of the amine adsorber and distribution of the amine adsorber in the mesopores of the inorganic oxide carrier.

In addition to the foregoing CO₂ adsorption profiles, the monolithic structural gas treatment body, in some embodiments, can be heated by heated nitrogen (N₂) or steam at a temperature of 100° C. until at least 90 percent or more of the adsorbed CO₂ is desorbed from the monolithic structural gas treatment body. The foregoing cycles of adsorption and desorption, in some embodiments, can be repeated at least 2000 times with the total amount of CO₂ adsorbed in each cycle decreasing no more than 10 percent from the initial cycle to the final cycle.

As an alternative to organic compounds comprising amine functionalities, monolithic structural gas treatment bodies described herein can comprise one or more alkali metal-based functionalities for CO₂ adsorption. In some embodiments, the alkali metal-based functionalities comprise alkali metal oxides operable for CO₂ adsorption. The alkali metal oxides can be dispersed throughout the inorganic oxide composition of the carrier and, therefore, reside in the mesoporosity and/or macroporosity of the hierarchical pore structure. Any alkali metal oxide compound can be employed with monolithic structural gas treatment bodies described herein. In some embodiments, for example, the alkali metal oxide comprises alkali metal carbonates, including sodium carbonate and/or potassium carbonate.

### II. Methods of Treating Gas Streams

In another aspect, methods of treating gas streams are described herein. A method, in some embodiments, comprises providing a monolithic structural gas treatment body, flowing a gas stream through the monolithic structural gas treatment body, and adsorbing CO₂ from the gas stream with the monolithic structural gas treatment body. In addition to properties (a)-(e) above, the monolithic structural gas treatment body comprises an outer peripheral wall, and a plurality of inner partition walls having dispersed throughout a carrier comprising an inorganic oxide composition, the carrier comprising an hierarchical pore structure having a macroporosity of at least 0.24-1.0 cc/g in pores of diameter ranging from 600 to 50,000 Angstroms, and a mesoporosity of at least 0.17 cc/g in pores of diameter ranging from 20 to 300 Angstroms, wherein a total porosity of the carrier is at least 0.41 cc/g in pores of diameter ranging from 20-100,000 Angstroms. One or more chemical species operable for the adsorption of CO₂ from the gas stream are associated with the carrier exhibiting the hierarchical pore structure.

Monolithic structural gas treatment bodies employed in methods described herein can have any composition, properties, architecture, and/or CO₂ adsorption/desorption performance criteria described in Section I hereinabove. In some embodiments, the monolithic structural gas treatment bodies are arranged in modules described above in references to FIG. 4.

Monolithic structural gas treatment bodies described herein can be produced by mixing up to 50-100% by weight an inorganic oxide composition, or a precursor which yields an inorganic oxide composition. The inorganic oxide composition includes, but is not limited to, titania (TiO₂), alumina (Al₂O₃), zirconia (ZrO₂), and/or mixtures thereof. As described herein, the inorganic oxide composition may further comprise inorganic binder and/or reinforcement agents, including glass and/or ceramic fibers. The resulting mixture can be kneaded into a clay-like substance and subsequently extruded from an extrusion molding machine to form a honeycomb-like monolithic catalyst structure comprising the outer partition wall, inner partition walls and longitudinal flow channels.

In some embodiments, the resulting mixture may contain and inorganic oxide mesoporous powder or mixtures of inorganic oxide mesoporous powders with a total mesoporosity of at least 0.17 cc/g in pores diameter ranging from 20 to 300 Angstroms. In some embodiments, the total mesoporosity of the powder or powder mixture is at least 0.30 cc/g in pores diameter ranging from 20 to 300 Angstroms.

The resulting mixture, in some embodiments, contains pore formers, consisting of organic materials such as corn starch to subsequently render a monolithic structural gas treatment body with a macroporosity greater than or equal to 0.05 cc/g in pores of diameter ranging from 5,000 to 50,000 Angstroms, once such organic material is removed during calcination by oxidation.

In some embodiments wherein the monolithic structural catalyst body is extruded, the extrusion formulation can comprise any number of peptizing agents, binding agents, extrusion aids, lubricants, plasticizers, reinforcement agents, and the like to assist in the extrusion process and/or generate the desired hierarchical pore structure via limiting loss of macroporosity and mesoporosity in inorganic oxide mesoporous powders. Examples of materials that may be included in an extrusion composition include, but are not limited to, glass fibers or strands, silicon carbide fibers, inorganic acids (e.g. phosphoric acid, nitric acid, etc.) organic acids (e.g. acetic acid, citric acid, formic acid, etc.), salts of organic acids (e.g. ammonium formate, ammonium acetate, ammonium citrate, etc.) cellulose compounds, starches, polyethylene oxide, stearic alcohols, alcohols, graphite, stearic acid, amines, oils, fats, and polymers. The extruded monolithic gas treatment body substrate can adopt a form-stable honeycomb-like monolithic structure comprising the outer partition wall, inner partition walls and longitudinal flow channels. The extrusion system may include extruder machines, a filter or screen, and an extrusion die. The filter or screen may be utilized to facilitate passage of the mixture through the die, for example to reduce clogging of the die, without removing filler, binders, pore formers, and reinforcement aids that provide advantageous product properties. In some embodiments, the screen is wedge shaped or exhibit wedge shaped features. The extruded monolithic structural gas treatment body substrate is subsequently dried or thermally treated, including thermal treatment to remove all or substantially all organic material, but without significant sintering the inorganic powders to prevent loss of mesoporosity. Sintering may be prevented by efficiently oxidizing the organic materials by flowing hot gas through the longitudinal flow channels to speed heat transfer rate and removal of heat due to oxidation of the organics, thus minimizing the calcination time and degree of sintering. In some embodiments, various metal oxides including tungsten oxide, vanadium oxide, and/or molybdenum oxide are excluded from the extrusion mixture. While offering strength advantages, such oxides can close mesoporosity and/or macroporosity during thermal treatment, including sintering.

It is generally desirable, when extruding the monolithic structural gas treatment body to employ sufficient energy to achieving intimate mixing of the compositional ingredients while minimizing additional energy that may have an adverse impact on particle packing characteristics, macroporosity, and powder mesoporosity, that provide advantageous product properties.

Additional energy is utilized in the mixing equipment to increase form-stability, and in the extrusion system to move the extrusion mixture through the extruder machines, filter or screen and die. As set forth above, lubricants and extrusion aids may be utilized in the starting composition for the structural body to minimize this additional energy in order to limit loss of mesoporosity and macroporosity. Other means of reducing additional energy known in the art, include maximizing mixer and extruder efficiency and minimizing wall friction in the screen and die.

Once formed, the monolithic structural gas treatment body can be impregnated with one or more chemical species operable for the capture of CO₂ from a gas stream flowed monolithic structural gas treatment body. The one or more chemical species operable for the adsorption of CO₂ from the gas stream are associated with the carrier exhibiting the hierarchical pore structure. The one or more chemical species for CO₂ adsorption can be dispersed throughout the carrier, residing in the mesopores, macropores or combinations thereof of the hierarchical pore structure. In being associated with the carrier, the chemical species for CO₂ adsorption can be dispersed throughout the inner partition walls. The one or more chemical species for CO₂ adsorption can comprise any organic or inorganic compound described in Section I hereinabove. Moreover, impregnation conditions are selected according to several considerations including, but not limited to, the identity of the chemical species for CO₂ adsorption, and the structural and compositional parameters of the monolithic structural gas treatment body. Following impregnation, the monolithic structural gas treatment body is dried. Drying can be achieved under ambient or heated conditions. In some embodiments, ambient air or heated air can be passed through the flow channels or cells of the monolithic structural gas treatment body.

In alternative embodiments, the monolithic structural gas treatment body can be coextruded with one or more chemical species operable for the capture of CO₂. In some embodiments, for example, the monolithic structural gas treatment body can be coextruded with inorganic chemical species, including the alkali metal oxides described herein.

In some embodiments, a method of treating a gas stream further comprises desorbing the CO₂ captured by the monolithic structural gas treatment body. The captured CO₂ can be desorbed by heating the monolithic structural gas treatment body. In some embodiments, the monolithic structural gas treatment body is heated with steam or heated nitrogen (N₂) to desorb the captured CO₂. Once desorbed, the CO₂ is further processed and stored.

These and other embodiments are further described in the following non-limiting examples.

### EXAMPLE 1—MONOLITHIC STRUCTURAL GAS TREATMENT BODY

A honeycomb-like monolithic structural gas treatment body substrate having composition and properties detailed in Section I above was prepared by extrusion according to the methods described herein. The compositional parameters and physical properties of the monolithic structural gas treatment body are summarized in Table VI.

TABLE VI
Monolithic Structural Gas Treatment Body

| | |
|---|---|
| Titania (TiO₂) Content, wt. % | 91 |
| Reinforcement agent (glass fibers), wt. % | 8 |
| Other inorganic oxide components, wt. % | 1 |
| Oxides of tungsten, vanadium, and/or molybdenum, | 0.02 |
| wt. % | |
| Oxidative iron and/or iron compounds (ppm) | <100 |
| Nominal Cross-sectional Shape | Square |
| Peripheral Wall Thickness (mm) | 0.5 |
| Average Inner Partition Wall Thickness (mm) | 0.23 |
| cpsi | 194 |
| Open Frontal Area (OFA) | 74% |
| Hydraulic Diameter (mm) | 147 |
| Transverse Compressive Strength (g/cm²) | >1000 |
| Flow Channel or Cell length (mm) | 153 |
| Macroporosity in pores of diameter ranging from 600 | 0.174 |
| to 5,000 Angstroms (cc/g) | |
| Macroporosity in pores of diameter ranging from | 0.094/0.059 |
| greater than 5,000 up to 50,000 Angstroms (cc/g) - | |
| bare/impregnated | |
| Mesoporosity in pores of diameter ranging from 20 to | 0.178/0.033 |
| 300 Angstroms (cc/g) - bare/impregnated | |
| Total porosity of monolithic structural gas treatment | 0.55 |
| body (cc/g) | |
| Surface area of monolithic structural gas treatment | 55 |
| body substrate (m²/g) | |
| Percent PEI in mesopores | 80% |

To impart CO₂ capture functionality, the monolithic structural gas treatment body substrate was then impregnated with an aqueous-based solution of polyethyleneimine (PEI) having a weight average molecular weight (Mw) of 800 g/mol. The monolithic structural gas treatment body substrate was dipped into the PEI solution for a sufficient time period to achieve equilibration between the substrate wall and PEI solution. The monolithic structural gas treatment body substrate was then removed from the PEI solution, and the cells of the substrate were subjected to dewatering to avoid or mitigate undesirable accumulation of the PEI into a film over cell wall surfaces. The PEI impregnated monolithic structural gas treatment body substrate was subsequently dried by flowing ambient air through the flow channels, the ambient air heated to an average temperature of 45° C. with a gas burner, and the flow imparting approximately a 3 in H₂O pressure drop across the monolithic structural gas treatment body until the inlet and outlet temperatures agreed within 1° C.

The monolithic structural gas treatment body was tested for CO₂ capture under the conditions:
1. Gas stream—ambient air or simulated air at 35° C. with 450 ppm CO₂, 20% O₂, and 2% H₂O by volume; and
2. Space velocity of gas stream—104,000 hr⁻¹.

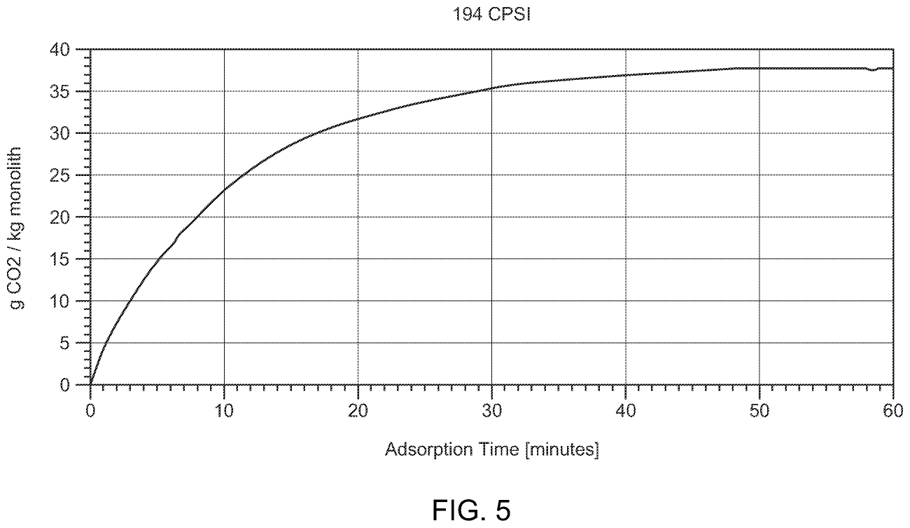

The CO₂ adsorption profile of the monolithic structural gas treatment body is provided in FIG. 5.

### EXAMPLE 2—MONOLITHIC STRUCTURAL GAS TREATMENT BODY

A honeycomb-like monolithic structural gas treatment body substrate having composition and properties detailed in Section I above was prepared by extrusion according to the methods described herein. The compositional parameters and physical properties of the monolithic structural gas treatment body are summarized in Table VII.

TABLE VII
Monolithic Structural Gas Treatment Body

| | |
|---|---|
| Alumina (Al₂O₃) Content, wt. % | 92 |
| Reinforcement agent (glass fibers), wt. % | 8 |
| Other inorganic oxides, wt. % | <1 |
| Oxides of tungsten, vanadium, and/or molybdenum, | 0.0 |
| wt. % | |
| Oxidative iron and/or iron compounds (ppm) | <100 |
| Nominal Cross-sectional Shape | Square |
| Peripheral Wall Thickness (mm) | 0.5 |
| Average Inner Partition Wall Thickness (mm) | 0.21 |
| cpsi | 155 |
| Open Frontal Area (OFA) | 80% |
| Hydraulic Diameter (mm) | 147 |
| Transverse Compressive Strength (g/cm²) | >1000 |
| Flow Channel or Cell length (mm) | 151 |
| Macroporosity in pores of diameter ranging from 600 | 0.185 |
| to 5,000 Angstroms (cc/g) | |
| Macroporosity in pores of diameter ranging from | 0.142 |
| greater than 5,000 up to 50,000 Angstroms (cc/g) - | |
| bare | |
| Mesoporosity in pores of diameter ranging from 20 to | 0.342 |
| 300 Angstroms (cc/g) - bare | |
| Total porosity of monolithic structural gas treatment | 0.80 |
| body (cc/g) | |
| Surface area of monolithic structural gas treatment | 132 |
| body substrate (m²/g) | |

The alumina-based monolithic structural gas treatment body of Table VII can be subsequently functionalized with PEI according to the impregnation procedure set forth in Example 1 above.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A monolithic structural gas treatment body comprising:
an outer peripheral wall, and a plurality of inner partition walls having dispersed throughout a carrier comprising an inorganic oxide composition, the carrier comprising an hierarchical pore structure having a macroporosity of 0.24-1.0 cc/g in pores of diameter ranging from 600 to 50,000 Angstroms, and a mesoporosity of at least 0.17 cc/g in pores of diameter ranging from 20 to 300 Angstroms, wherein a total porosity of the carrier is at least 0.41 cc/g in pores of diameter ranging from 20-100,000 Angstroms, and the monolithic structural gas treatment body has the following structural features:
(a) hydraulic diameter of at least 100 mm;
(b) at least 85 cells per square inch (cpsi);
(c) average thickness of the inner partition walls of 0.1 mm to 0.3 mm;
(d) open frontal area of at least 65 percent; and
(e) transverse compressive strength of at least 500 g/cm².

2. The monolithic structural gas treatment body of claim 1, wherein the macroporosity comprises a first porosity distribution of at least 0.08 cc/g in pores of diameter ranging from 600 to 5,000 Angstroms, and a second porosity distribution of at least 0.16 g/cc in pores of diameter ranging from greater than 5,000 Angstroms up to 50,000 Angstroms.

3. The monolithic structural gas treatment body of claim 1, wherein the inorganic oxide composition comprises less than 5 wt. % of oxides of tungsten, vanadium, iron, and/or molybdenum.

4. The monolithic structural gas treatment body of claim 1, wherein the inorganic oxide composition is alumina (Al₂O₃) based.

5. The monolithic structural gas treatment body of claim 1, wherein the inorganic oxide composition is titania (TiO₂) based.

6. The monolithic structural gas treatment body of claim 1, wherein the hydraulic diameter is at least 130 mm.

7. The monolithic structural gas treatment body of claim 1, wherein the macroporosity is 0.24 cc/g to 0.60 cc/g.

8. (canceled)

9. The monolithic structural gas treatment body of claim 1, wherein the mesoporosity is 0.30 cc/g to 0.70 cc/g in pores of diameter ranging from 20 to 300 Angstroms.

10. The monolithic structural gas treatment body of claim 9, wherein the total porosity of the carrier is 0.50 cc/g to 1.3 cc/g in pores of diameter ranging from 20-100,000 Angstroms

11. The monolithic structural gas treatment body of claim 1, wherein the transverse compressive stress is at least 750 g/cm².

12. The monolithic structural gas treatment body of claim 1, wherein the average thickness of the inner partition walls is 0.1 mm to 0.2 mm.

13. The monolithic structural gas treatment body of claim 1 further comprising one more fiber reinforcing agents selected from the group consisting of glass fibers, ceramic fibers, and silicon carbide fibers.

14. (canceled)

15. The monolithic structural gas treatment body of claim 13, wherein the one or more fiber reinforcing agents are present in the monolithic structural gas treatment body in an amount of 3-30 weight percent.

16. The monolithic structural gas treatment body of claim 1 further comprising one or more chemical species operable for the capture of CO₂ from a gas stream flowed monolithic structural gas treatment body.

17. The monolithic structural gas treatment body of claim 16, wherein one or more chemical species operable for the capture of CO₂ from the gas stream are associated with the carrier exhibiting the hierarchical pore structure.

18. The monolithic structural gas treatment body of claim 17, wherein the one or more chemical species comprise one or more organic compounds comprising amine functionalities.

19. (canceled)

20. (canceled)

21. The monolithic structural gas treatment body of claim 18, wherein organic compounds comprise polyalkyleneimines.

22. (canceled)

23. The monolithic structural gas treatment body of claim 17, wherein the one or more chemical species comprise one or more inorganic compounds.

24. The monolithic structural gas treatment body of claim 18, wherein at least 80 percent of the one or more organic compounds are contained in the mesoporosity.

25. The monolithic structural gas treatment body of claim 18, wherein at least 70 percent of the one or more organic compounds are contained in the mesoporosity, and mesoporosity volume is reduced less than 70 percent by inclusion of the one or more organic compounds.

26. The monolithic structural gas treatment body of claim 18, wherein the monolithic structural gas treatment body absorbs at least 15 g of CO₂ per kilogram of the monolithic structural gas treatment body within 15 minutes of a gas stream being flowed through the monolithic structural gas treatment body at a space velocity of 110,000 hr⁻¹, the gas stream being ambient air or simulated air at 35° C. with 450 ppm CO₂, 20% O₂, and 2% H₂O by volume.

27. The monolithic structural gas treatment body of claim 26, wherein the monolithic structural gas treatment body adsorbs at least 35 g of CO₂ per kilogram of the monolithic structural gas treatment body after 100 minutes.

28. The monolithic structural gas treatment body of claim 26 having a mesoporosity of 0.30 cc/g to 0.70 cc/g and a macroporosity of 0.24 cc/g to 0.60 cc/g adsorbs at least 25 g per kilogram of the monolithic structural gas treatment body within 15 minutes.

29. The monolithic structural gas treatment body of claim 28, wherein the monolithic structural gas treatment body adsorbs at least 45 g of CO₂ per kilogram of the monolithic structural gas treatment body after 100 minutes.

30. (canceled)

31. (canceled)

32. The monolithic structural gas treatment body of claim 16, wherein the inorganic oxide composition includes less than 100 ppm iron or iron compounds, the iron or iron compounds operable for the oxidation and/or other degradation of the one or more chemical species operable for the capture of CO₂ from a gas stream.

33. The monolithic structural gas treatment body of claim 18 wherein the one or more organic compounds increase the transverse compressive stress of the monolithic structural gas treatment body by at least 40 percent.
